(19) United States
(12) Patent Application Publication
(10) Pub. No.: US 2020/0292332 A1
(43) Pub. Date: Sep. 17, 2020

(54) MAP INFORMATION DISTRIBUTION SYSTEM AND VEHICLE

(71) Applicant: TOYOTA JIDOSHA KABUSHIKI KAISHA, Toyota-shi (JP)

(72) Inventors: Shin SAKURADA, Toyota-shi (JP); Sinae KIM, Nagoya-shi (JP); Takayuki YANO, Nisshin-shi (JP); Naoki YAMAMURO, Nagoya-shi (JP); Takashi HAYASHI, Aichi-gun (JP); Koji MIYATA, Nagoya-shi (JP)

(73) Assignee: TOYOTA JIDOSHA KABUSHIKI KAISHA, Toyota-shi (JP)

(21) Appl. No.: 16/782,537

(22) Filed: Feb. 5, 2020

(30) Foreign Application Priority Data
Mar. 12, 2019 (JP) 2019-044458

(51) Int. Cl. G01C 21/32; G06K 9/00; G01C 21/36

(52) U.S. Cl. CPC G01C 21/32; G01C 21/3602; G01C 21/367; G06K 9/00791

(57) ABSTRACT

A map information distribution system is a map information distribution system in which a server distributes map information to a vehicle via a telecommunication line and uses various information acquired from the vehicle to update the map information, and a vehicle includes an update control section that determines whether a condition for acquiring peripheral information of the vehicle, which is used to update the map information, is satisfied, acquires the peripheral information at timing of satisfying the condition, and transmits the acquired peripheral information to the server.

### INCORPORATION BY REFERENCE

The disclosure of Japanese Patent Application No. 2019-044458 filed on Mar. 12, 2019 including the specification, drawings and abstract is incorporated herein by reference in its entirety.

### BACKGROUND

### 1. Technical Field

The present disclosure relates to a map information distribution system in which a server distributes map information to a vehicle via a telecommunication line and updates the map information using various information acquired from the vehicle, and to a vehicle.

### 2. Description of Related Art

In Japanese Patent Application Publication No. 2008-164373 (JP 2008-164373 A) and JP 2008-164821 A, systems are disclosed in each of which a vehicle transmits travel path information that is not included in map data provided in a navigation system to a map distribution center, and the map distribution center updates map information using the travel path information transmitted from the vehicle.

### SUMMARY

According to the systems disclosed in JP 2008-164373 A and JP 2008-164821 A, plural vehicles randomly acquire and transmit the travel path information to the map distribution center, which possibly places an enormous burden on communication traffic between each of the vehicles and the map distribution center in association with an update of the map information.

The present disclosure has been made in view of the above problem and therefore has a purpose of providing a map information distribution system and a vehicle capable of suppressing placement of an enormous burden on communication traffic that is associated with an update of map information.

A map information distribution system according to an aspect of the present disclosure is a map information distribution system in which a server distributes map information to a vehicle via a telecommunication line and uses various information acquired from the vehicle to update the map information, and the vehicle includes an update control section that determines whether a condition for acquiring peripheral information of the vehicle, which is used to update the map information, is satisfied, acquires the peripheral information at timing of satisfying the condition, and transmits the acquired peripheral information to the server.

In the case where the map information that is stored in a map database provided in the vehicle does not include map information around the vehicle, the update control section may acquire the peripheral information. According to such a configuration, the vehicle acquires and transmits the peripheral information only in the case where the map information that is stored in the map database does not include the map information around the vehicle. Thus, it is possible to suppress placement of an enormous burden on communication traffic.

In the case where specified duration or longer has elapsed since the map information around the vehicle is updated, the update control section may acquire the peripheral information. According to such a configuration, the vehicle acquires and transmits the peripheral information only in the case where the specified duration or longer has elapsed since the map information around the vehicle is updated. Thus, it is possible to suppress the placement of the enormous burden on the communication traffic.

A vehicle according to another aspect of the present disclosure is a vehicle that receives map information distributed from a server via a telecommunication line and transmits various information to the server, so as to assist with update processing of the map information. The vehicle includes an update control section that determines whether a condition for acquiring peripheral information of the vehicle, which is used to update the map information, is satisfied, acquires the peripheral information at timing of satisfying the condition, and transmits the acquired peripheral information to the server.

According to the map information distribution system and the vehicle of the present disclosure, the peripheral information is acquired and transmitted only in the case where the condition for acquiring the peripheral information of the vehicle, which is used to update the map information, is satisfied. Therefore, it is possible to suppress the placement of the enormous burden on the communication traffic in association with the update processing of the map information.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic view illustrating a configuration of a map information distribution system as an embodiment of the present disclosure;

FIG. 2 is a block diagram illustrating a configuration of a vehicle in FIG. 1;

FIG. 3 is a block diagram illustrating a configuration of a server in FIG. 1; and

FIG. 4 is a flowchart illustrating a procedure of map information update processing as the embodiment of the present disclosure.

### DETAILED DESCRIPTION OF EMBODIMENTS

A description will hereinafter be made on a configuration of a map information distribution system as an embodiment of the present disclosure with reference to the drawings.

### Overall Configuration

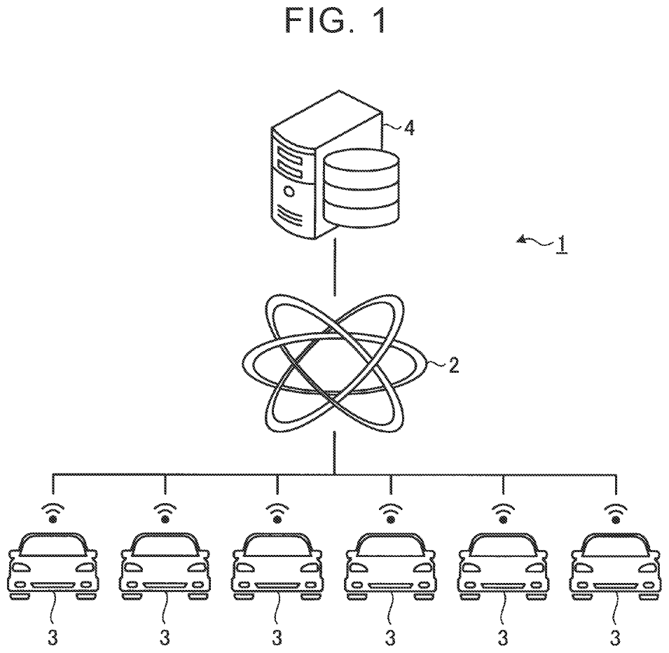

First, a description will be made on an overall configuration of the map information distribution system as the embodiment of the i present disclosure with reference to FIG. 1.

FIG. 1 is a schematic view illustrating the configuration of the map information distribution system as the embodiment of the present disclosure. As illustrated in FIG. 1, a map information distribution system 1 as the embodiment of the present disclosure is a system that distributes map information to a vehicle 3 via a telecommunication line 2 such as the Internet or a cellular phone network and updates the map information using various information acquired from the vehicle 3. The map information distribution system 1 includes, as main components, the plural vehicles 30 and a server 4.

### Vehicle Configuration

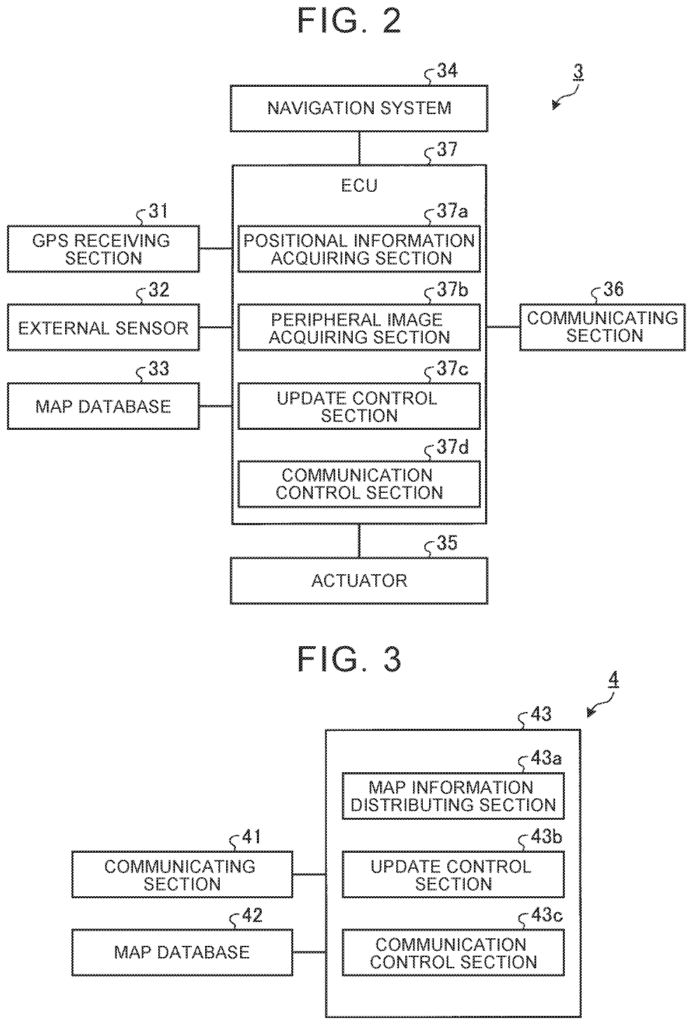

Next, a description will be made on a configuration of the vehicle 3 with reference to FIG. 2.

FIG. 2 is a block diagram illustrating the configuration of the vehicle 3 in FIG. 1. As illustrated in FIG. 2, the vehicle 3 includes a Global Positioning System (GPS) receiving section 31, an external sensor 32, a map database 33, a navigation system 34, an actuator 35, a communicating section 36, and an electronic control unit (ECU) 37.

The GPS receiving section 31 functions as a position measuring section that measures a position of the vehicle 3. The GPS receiving section 31 receives signals from three or more GPS satellites and thereby measures the position (for example, latitude and longitude) of the vehicle 3. The GPS receiving section 31 outputs information on the measured position of the vehicle 3 to the ECU 37. Note that the vehicle 3 may use positional information of a fixed obstacle such as a utility pole that is included in the map information stored in the map database 33 and a detection result of the external sensor 32 so as to measure the position of the vehicle 3 by a simultaneous localization and mapping (SLAM) technology.

The external sensor 32 includes an imaging device, a radar, and lidar. The imaging device is imaging equipment that captures an image of an external circumstance of the vehicle 3. The imaging device is provided on a back side of a front windshield of the vehicle 3 and a back surface of the vehicle 3. The imaging device may be provided on right and left surfaces of the vehicle 3. The imaging device outputs imaging information, in which images in front of and at the rear of the vehicle 3 are captured, to the ECU 37. The imaging device may be a monocular camera or may be a stereo camera. The stereo camera has two capturing sections that are arranged to replicate binocular disparity. The imaging information of the stereo camera includes information in a depth direction.

The radar uses a radio wave (for example, a millimeter wave) to detect an obstacle around the vehicle 3. The radar transmits the radio wave around the vehicle 3 and receives the radio wave reflected by the obstacle, so as to detect the obstacle. The radar outputs detected obstacle information to the ECU 37. In addition to the above-described fixed obstacle, the obstacles include dynamic obstacles such as a bicycle and another vehicle. The lidar uses light to detect the obstacle around the vehicle 3. The lidar transmits the light around the vehicle 3 and receives the reflected light by the obstacle, so as to measure a distance to a reflection point and detect the obstacle. The lidar outputs the detected obstacle information to the ECU 37. The lidar and the radar do not always have to be provided together.

The map database 33 is a database that stores the map information. The map database 33 is formed in a storage such as a hard disk drive (HDD) mounted on the vehicle 3. The map database 33 can be connected to the server 4 by wireless communication via the communicating section 36. The map database 33 uses the latest map information stored in the server 4 to update the map information periodically. The map information includes positional information of a road (positional information per lane), information on a road shape (a curve, a type of a straight section, curvature of the curve, and the like), information on a road width (information on a lane width), information on a speed limit on the road, and image information (three-dimensional information) around the road. The map information also includes positional information of an intersection and a fork in the road, positional information of a stop line, positional information of a crosswalk, and positional information of a signal. The map information may include information on a gradient of the road and information on a cant of the road. The map information may further include the positional information and shape information of the fixed obstacles such as a curbstone, the utility pole, a pole, a guard rail, a wall, and a building. The map information may include positional information and shape information of road surface painting such as a character and a mark drawn on a road surface. The road surface painting may include a manhole. The map information may include information on a signboard provided above the road and information on a traffic sign provided on a road side.

The navigation system 34 calculates a target route from the current position of the vehicle 3 to a destination by a well-known method on the basis of a preset destination, the position of the vehicle 3 measured by the GPS receiving section 31, and the map information in the map database 33, and provides a route guide along the target route. The destination is set when an occupant of the vehicle 3 operates an input button (or a touchscreen) provided in the navigation system 34.

The actuator 35 is a device that executes travel control of the vehicle 3. The actuator 35 includes a throttle actuator, a brake actuator, and a steering actuator. The throttle actuator controls a supply amount of air to an engine (a throttle opening degree) according to a control signal from the ECU 37, and thereby controls drive power of the vehicle 3. In the case where the vehicle 3 is a hybrid vehicle, the drive power is controlled not only by controlling the supply amount of the air to the engine but also by a motor as a power source receiving the control signal from the ECU 37. In the case where the vehicle 3 is an electric vehicle, the motor as the power source receives the control signal from the ECU 37 to control the drive power. In any of these cases, the motor as the power source constitutes the actuator 35. The brake actuator controls a brake system according to the control signal from the ECU 37 and thereby controls a braking force applied to each wheel of the vehicle 3. The steering actuator controls driving of an assist motor, which controls steering torque, in an electric power steering system according to the control signal from the ECU 37.

The communicating section 36 is constructed of a wireless communication circuit for the wireless communication and the like, and performs information communication with the server 4 via the telecommunication line 2. The communicating section 36 may perform inter-vehicle communication with the other vehicle capable of the inter-vehicle communication. In addition, the communicating section 36 may perform road-to-vehicle communication with a road-side transceiver that is provided along the road.

The ECU 37 is an electronic control unit that has a central processing unit (CPU), read only memory (ROM), random access memory (RAM), a controller area network (CAN) communication circuit, and the like. In this embodiment, the ECU 37 loads a computer program stored in the ROM into the RAM, executes the computer program loaded into the RAM by the CPU, and thereby functions as a positional information acquiring section 37a, a peripheral image acquiring section 37b, an update control section 37c, and a communication control section 37d.

The positional information acquiring section 37a uses the GPS receiving section 31 to acquire the positional information of the vehicle 3. The peripheral image acquiring section 37b uses the external sensor 32 to acquire a peripheral image of the vehicle 3. The update control section 37c executes map information update processing, which will be described later, to transmit the various information to the server 4 via the telecommunication line 2. The communication control section 37d controls the information communication with the server 4 via the telecommunication line 2.

### Server Configuration

Next, a description will be made on a configuration of the server 4 with reference to FIG. 3.

FIG. 3 is a block diagram illustrating the configuration of the server 4 in FIG. 1. As illustrated in FIG. 3, the server 4 includes a communicating section 41, a map database 42, and a server main body 43.

The communicating section 41 is constructed of a wireless communication circuit for the wireless communication and the like, and performs the information communication with the vehicle 3 via the telecommunication line 2.

The map database 42 is a database that stores the above-described map information.

The server main body 43 is constructed of a well-known information processor and functions as a map information distributing section 43a, an update control section 43b, and a communication control section 43c when an internal arithmetic processing unit executes a computer program. The map information distributing section 43a distributes the map information, which is stored in the map database 42, to the vehicle 3 via the telecommunication line 2. The update control section 43b executes the map information update processing, which will be described later, and thereby updates the map information stored in the map database 42 by using the various information acquired from the vehicle 3. The communication control section 43c controls the information communication with the vehicle 3 via the telecommunication line 2.

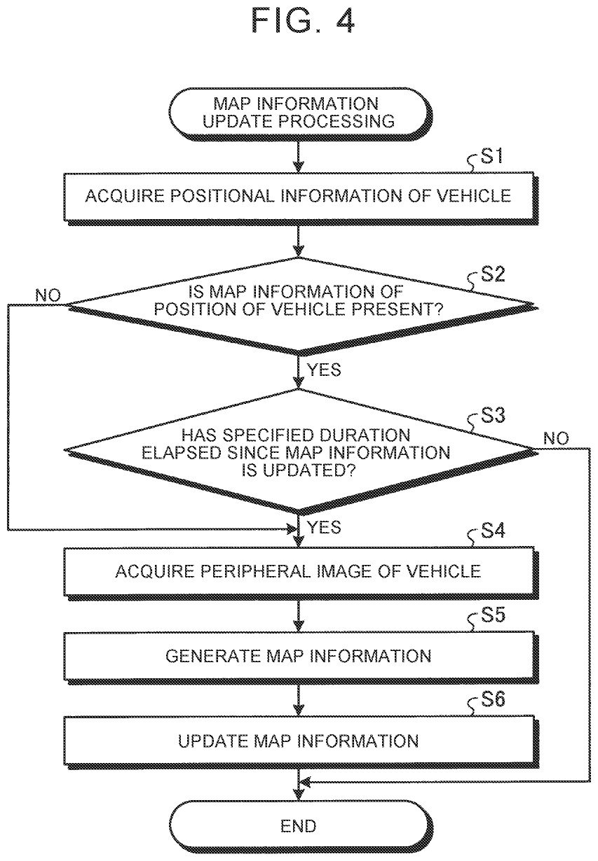

The map information distribution system 1 with such a configuration executes the map information update processing, which will be described later, and thereby suppresses placement of an enormous burden on communication traffic between the vehicle 3 and the server 4 that is associated with update processing of the map information in the map database 42. A description will hereinafter be made on operation of the map information distribution system 1 at the time of executing this map information update processing with reference to a flowchart illustrated in FIG. 4.

### Map Information Update Processing

FIG. 4 is a flowchart illustrating a procedure of the map information update processing as the embodiment of the present disclosure. The flowchart illustrated in FIG. 4 is initiated at timing when an ignition switch of the vehicle 3 is switched from an OFF state to an ON state, and the map information update processing proceeds to processing in step S1. While the ignition switch of the vehicle 3 remains in the ON state, the map information update processing is repeatedly executed every time specified duration elapses after termination of the last map information update processing.

In the processing in step S1, the positional information acquiring section 37a uses the GPS receiving section 31 to acquire the positional information of the vehicle 3. In this way, the processing in step S1 is completed, and the map information update processing proceeds to processing in step S2.

In the processing in step S2, the update control section 37c determines whether the map information around the position of the vehicle 3, which is acquired in the processing in step S1, is stored in the map database 33. As a result of the determination, if the map information is stored in the map database 33 (step S2: Yes), the update control section 37c determines that there is history in the past, and the map information update processing proceeds to processing in step S3. On the other hand, if the map information is not stored in the map database 33 (step S2: No), the update control section 37c determines that there is no history in the past, and the map information update processing proceeds to processing in step S4.

In the processing in step S3, the update control section 37c determines whether the specified duration has elapsed since the map information around the position of the vehicle 3 is updated. As a result of the determination, if the specified duration has elapsed (step S3: Yes), the update control section 37c determines that a map information update frequency is low, and the map information update processing proceeds to processing in step S4. On the other hand, if the specified duration has not elapsed (step S3: No), the update control section 37c terminates a series of the map information update processing.

In the processing in step S4, the peripheral image acquiring section 37b uses the external sensor 32 to acquire the peripheral image of the vehicle 3. Then, the communication control section 37d transmits the positional information of the vehicle 3, which is acquired by the positional information acquiring section 37a via the telecommunication line 2, and the information on the peripheral image, which is acquired by the peripheral image acquiring section 37b via the telecommunication line 2, as information for updating the map information to the server 4. In this way, the processing in step S4 is completed, and the map information update processing proceeds to processing in step S5.

In the processing in step S5, the update control section 43b uses the positional information transmitted from the vehicle 3 and the information on the peripheral image to generate the map information. In this way, the processing in step S5 is completed, and the map information update processing proceeds to processing in step S6.

In the processing in step S6, the update control section 43b uses the map information generated in the processing in step S5 to update the map information stored in the map database 42. In this way, the processing in step S6 is completed, and the series of the map information update processing is terminated.

As it is apparent from the description so far, in the map information update processing as the embodiment of the present disclosure, the vehicle 3 acquires and transmits the information for updating the map information at a stage of satisfying the specified conditions, such as the presence or absence of the past history and the update frequency, for acquiring the peripheral information of the vehicle 3 used to update the map information. Therefore, it is possible to suppress the vehicle 3 from randomly acquiring and transmitting the information to the server 4 and to suppress the placement of the enormous burden on the communication traffic between the vehicle 3 and the server 4 in association with the update of the map information. Note that the vehicle 3 may determine whether to transmit the information in consideration of a situation of a load on the communication traffic. In addition, in this embodiment, the information is acquired and transmitted at the stage of satisfying the specified conditions. However, such conditions may not be provided for the acquisition of the information, and a condition may be set for the information to be transmitted among the acquired information.

The embodiment, to which the present disclosure devised by the present inventors is applied, has been described so far. A gist of the present disclosure is not restricted by the description and the drawings constituting parts of the present disclosure.

That is, all of the other embodiments, examples, operating techniques, and the like that are implemented by those skilled in the art on the basis of this embodiment are included in the scope of the present disclosure.

What is claimed is:

1. A map information distribution system in which a server distributes map information to a vehicle via a telecommunication line and uses various information acquired from the vehicle to update the map information, wherein
the vehicle includes an update control section that determines whether a condition for acquiring peripheral information of the vehicle, which is used to update the map information, is satisfied, acquires the peripheral information at timing of satisfying the condition, and transmits the acquired peripheral information to the server.

2. The map information distribution system according to claim 1, wherein
in the case where the map information that is stored in a map database provided in the vehicle does not include map information around the vehicle, the update control section acquires the peripheral information.

3. The map information distribution system according to claim 1, wherein
in the case where specified duration or longer has elapsed since the map information around the vehicle is updated, the update control section acquires the peripheral information.

4. A vehicle that receives map information distributed from a server via a telecommunication line and transmits various information to the server, so as to assist with update processing of the map information, the vehicle comprising:
an update control section that determines whether a condition for acquiring peripheral information of the vehicle, which is used to update the map information, is satisfied, acquires the peripheral information at timing of satisfying the condition, and transmits the acquired peripheral information to the server.
